(19) United States
(12) Patent Application Publication
(10) Pub. No.: US 2021/0133279 A1
(43) Pub. Date: May 6, 2021

(54) UTILIZING A NEURAL NETWORK TO GENERATE LABEL DISTRIBUTIONS FOR TEXT EMPHASIS SELECTION

(71) Applicant: Adobe Inc., San Jose, CA (US)

(72) Inventors: Amirreza Shirani, Houston, TX (US); Franck Dernoncourt, Sunnyvale, CA (US); Paul Asente, Redwood City, CA (US); Nedim Lipka, Santa Clara, CA (US); Seokhwan Kim, San Jose, CA (US); Jose Echevarria, San Jose, CA (US)

(21) Appl. No.: 16/672,733

(22) Filed: Nov. 4, 2019

(51) Int. Cl. G06F 17/24; G06N 3/04; G06F 17/27; G06N 5/04

(52) U.S. Cl. CPC G06F 17/24; G06N 5/04; G06F 17/2765; G06N 3/0427

(57) ABSTRACT

The present disclosure relates to utilizing a neural network to flexibly generate label distributions for modifying a segment of text to emphasize one or more words that accurately communicate the meaning of the segment of text. For example, the disclosed systems can utilize a neural network having a long short-term memory neural network architecture to analyze a segment of text and generate a plurality of label distributions corresponding to the words included therein. The label distribution for a given word can include probabilities across a plurality of labels from a text emphasis labeling scheme where a given probability represents the degree to which the corresponding label describes the word. The disclosed systems can modify the segment of text to emphasize one or more of the included words based on the generated label distributions.

### BACKGROUND

Recent years have seen significant improvements in hardware and software platforms for generating, formatting, and editing digital text representations. For example, many conventional systems analyze and modify a segment of digital text (e.g., a digital quote to be presented on a social media platform) to visually emphasize one or more words from the digital text (e.g., by making the word(s) appear larger or by underlining the words). Indeed, such systems often employ digital text emphasis techniques to improve the comprehension and appearance of social media posts, digital presentations, and/or digital documents. Although conventional systems can modify segments of digital text to emphasize particular words, such systems are often inflexible in that they rigidly emphasize words based on the visual attributes of those words, thereby failing to accurately communicate the meaning or intent of the digital text or model subjectivity of emphasizing pertinent portions of digital text.

These, along with additional problems and issues, exist with regard to conventional text emphasis systems.

### SUMMARY

One or more embodiments described herein provide benefits and/or solve one or more of the foregoing or other problems in the art with systems, methods, and non-transitory computer-readable media that utilize a neural network to generate label distributions that can be utilized to emphasize one or more words in a segment of text. For example, in one or more embodiments, the disclosed systems train a deep sequence labeling neural network (e.g., having a long short-term memory neural network architecture) to model text emphasis by learning label distributions. Indeed, the disclosed systems train the neural network to generate label distributions for text segments based on inter-subjectivities represented in one or more datasets that include training segments of text and corresponding distributions of text annotations across a plurality of labels. The disclosed systems use the trained neural network to analyze a segment of text and generate label distributions that indicate, for the words included therein, probabilities for emphasis selection across a plurality of labels. Based on the label distributions, the disclosed systems modify the segment of text to emphasize one or more of the included words. In this manner, the disclosed systems can flexibly modify text segments to emphasize words that accurately communicate the meaning of the included text and capture inter-subjectivity via learning label distributions.

Additional features and advantages of one or more embodiments of the present disclosure are outlined in the following description.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a text emphasis system can operate in accordance with one or more embodiments;

FIG. 2 illustrates a block diagram of a text emphasis system modifying a segment of text to emphasize one or more words in accordance with one or more embodiments;

FIG. 3 illustrates a schematic diagram of a text label distribution neural network in accordance with one or more embodiments;

FIG. 4 illustrates a block diagram of training a text label distribution neural network to generate label distributions in accordance with one or more embodiments;

FIG. 5 illustrates a block diagram modifying a segment of text based on a plurality of label distributions in accordance with one or more embodiments;

FIG. 6 illustrates a block diagram of utilizing an emphasis candidate ranking model to modify a segment of text in accordance with one or more embodiments;

FIG. 7 illustrates a table reflecting experimental results regarding the effectiveness of the text label distribution neural network in accordance with one or more embodiments;

FIG. 8 illustrates a table reflecting experimental results regarding the effectiveness of the emphasis candidate ranking model in accordance with one or more embodiments;

FIG. 9 illustrates an example schematic diagram of a text emphasis system in accordance with one or more embodiments;

FIG. 10 illustrates a flowchart of a series of acts for modifying a segment of text to emphasize one or more words in accordance with one or more embodiments; and

FIG. 11 illustrate a block diagram of an exemplary computing device in accordance with one or more embodiments.

### DETAILED DESCRIPTION

One or more embodiments described herein include a text emphasis system that utilizes a neural network to generate label distributions used for generating a semantic-based layout of text segments. In particular, the text emphasis system can utilize end-to-end label distribution learning techniques to train a deep sequence labeling neural network (e.g., having a long short-term memory neural network architecture) to generate label distributions for words included in text segments. For example, the text emphasis system trains the neural network utilizing a dataset that includes training segments of text and corresponding distributions of text annotations across a plurality of labels (e.g., obtained from a crowd-sourcing platform). In this manner, the text emphasis system can utilize a text label distribution neural network and word embedding to capture inter-subjectivity. The text emphasis system can identify a segment of text and utilize the trained neural network to analyze the segment of text and generate, for the words included therein, label distributions that indicate probabilities for emphasis selection across a plurality of labels from a labeling scheme. Based on the generated label distributions, the text emphasis system modifies the segment of text to emphasis one or more of the included words.

To provide an example, in one or more embodiments, the text emphasis system identifies a segment of text that includes a plurality of words. The text emphasis system utilizes word embeddings as input to a text label distribution neural network to model inter-subjectivity of emphasizing portions of text. In particular, based on the word embeddings, the text emphasis system utilizes the text label distribution neural network to generate a plurality of label distributions for the plurality of words by determining, for a given word, a distribution of probabilities across a plurality of emphasis labels in a text emphasis labeling scheme. The text emphasis system modifies the segment of text to emphasize one or more words from the plurality of words based on the plurality of label distributions.

As just mentioned, in one or more embodiments, the text emphasis system trains a neural network—i.e., a text label distribution neural network—to generate label distributions for words included in text segments. In particular, the text emphasis system utilizes the text label distribution neural network to analyze training segments of text and predict label distributions across labels from a text emphasis labeling scheme. The text emphasis system compares the predicted label distributions with ground truth label distributions across the labels from the text emphasis labeling scheme and determine the corresponding loss used for modifying parameters of the text label distribution neural network. In one or more embodiments, the text emphasis system utilizes a Kullback-Leibler Divergence loss function to compare the predicted label distributions with the ground truth label distributions and determine the resulting losses.

In some embodiments, the text emphasis system generates the ground truth label distributions based on annotations for the words in the training segments of text. For example, the text emphasis system generates a text annotation dataset that includes, for a given word included in a training segment of text, a distribution of text annotations across a plurality of labels. In one or more embodiments, the text emphasis system generates the text annotation dataset by collecting annotations provided by annotators via a crowd-sourcing platform. The text emphasis system utilizes the distributions of text annotations for the words of a training segment of text as the ground truth label distributions corresponding to that training segment of text.

Additionally, as mentioned above, the text emphasis system can utilize the text label distribution neural network to generate a plurality of label distributions for a plurality of words included in a given segment of text. In one or more embodiments, the text label distribution neural network includes a long short-term memory (LSTM) neural network architecture. For example, the text label distribution neural network includes an encoding layer that includes a plurality of bi-directional long short-term memory neural network layers. The text label distribution neural network utilizes the bi-directional long short-term memory neural network layers to analyze word embeddings corresponding to the plurality of words of a segment of text and generate corresponding feature vectors. The text label distribution neural network then generates the label distributions for the plurality of words based on the feature vectors.

In one or more embodiments, the text label distribution neural network further includes one or more attention mechanisms. The text label distribution neural network utilizes the attention mechanism(s) to generate attention weights corresponding to the plurality words of the segment of text based on the word embeddings. By generating attention weights, the text label distribution neural network can assign a higher weighting to more relevant parts of the input. In some embodiments, text label distribution neural network generates the label distributions for the plurality of words further based on the attention mechanisms.

As further mentioned above, in one or more embodiments, the text emphasis system modifies a segment of text to emphasize one or more words based on the plurality of label distributions generated by the text label distribution neural network. To illustrate, the text emphasis system can modify a segment of text by applying, to the selected words, at least one of a color, a background, a text font, or a text style (e.g., italics, boldface, underlining, etc.).

The text emphasis system can modify a segment of text to emphasize one or more words using various methods. For example, in one or more embodiments, the text emphasis system identifies and modifies a word corresponding to a top probability for emphasis based on the plurality of label distributions. In some embodiments, the text emphasis system identifies and modifies multiple words corresponding to top probabilities for emphasis. In still further embodiments, the text emphasis system applies different modifications to different words of a text segment based on the label distributions corresponding to those words (e.g., modifies a given word with a relatively high probability for emphasis so that the word is emphasized more than other emphasized words).

As mentioned above, conventional text emphasis systems suffer from several technological shortcomings that result in inflexible and inaccurate operation. For example, conventional text emphasis systems are often inflexible in that they rigidly emphasize one or more words in a segment of text based on the visual attributes of those words. For example, a conventional system may emphasize a particular word in a text segment based on the length of the word. Such systems fail to flexibly analyze other attributes that may render a different word appropriate—perhaps even more appropriate—for emphasis.

In addition to flexibility concerns, conventional text emphasis systems are also inaccurate. In particular, because conventional systems typically emphasize one or more words in a text segment based on the visual attributes of those words, such systems often inaccurately emphasize meaningless portions of text. Indeed, such conventional systems may select an insignificant word for emphasis (e.g., “the”), leading to an inaccurate or misleading portrayal of a text segment. Moreover, as text emphasis patterns are often person- and domain-specific, conventional systems fail to model subjectivity in selecting portions of text to emphasize (e.g., different annotators will often have different preferences).

The text emphasis system provides several advantages over conventional systems. For example, the text emphasis system can operate more flexibly than conventional systems. In particular, by utilizing a text label distribution neural network to analyze a segment of text, the text emphasis system flexibly emphasizes one or more words of the segment of text based on various factors indicative of how a given word contributes to the meaning of the text. Indeed, the text emphasis system avoids relying solely on the visual attributes of words when emphasizing text.

Additionally, the text emphasis system can operate more accurately than conventional systems. Indeed, by emphasizing one or more words of a text segment based on various factors analyzed by a text label distribution neural network, the text emphasis system more accurately selects meaningful words from a text segment for emphasis. In addition, by utilizing a label distribution neural network, the text emphasis system directly models inter-subjectivity across annotations, thus more accurately modeling selections/choices of annotators.

As mentioned above, the text emphasis system modifies a segment of text to emphasize one or more words included therein. A segment of text (also referred to as a text segment) can include a digital textual representation of one or more words. For example, a segment of text can include one or more words that have been written, typed, drawn, or otherwise provided within a digital visual textual representation. In one or more embodiments, a segment of text includes one or more digital words included in short-form text content, such as a quote, a motto, or a slogan. In some embodiments, however, a segment of text includes one or more words included in long-form text content, such as a digital book, an article, or other document.

As further mentioned, the text emphasis system can utilize a text label distribution neural network to analyze text segments and generate label distributions. In one or more embodiments, a neural network includes a machine learning model that can be tuned (e.g., trained) based on inputs to approximate unknown functions used for generating the corresponding outputs. In particular, a neural network includes a model of interconnected artificial neurons (e.g., organized in layers) that communicate and learn to approximate complex functions and generate outputs based on a plurality of inputs provided to the model. For instance, a neural network can include one or more machine learning algorithms. In addition, a neural network can include an algorithm (or set of algorithms) that implements deep learning techniques that utilize a set of algorithms to model high-level abstractions in data. To illustrate, a neural network can include a convolutional neural network, a recurrent neural network (e.g., a LSTM neural network), a generative adversarial neural network, and/or a graph neural network.

In one or more embodiments, a text label distribution neural network includes a computer-implemented neural network that generates label distributions. For example, a text label distribution neural network can include a neural network that analyzes a segment of text and generates label distributions for the words included therein, predicting which words, when emphasized, communicate the meaning of the text. For example, the text label distribution neural network can include a neural network, such as a neural network having a long short-term memory (LSTM) neural network architecture (e.g., having one or more bi-directional long short-term memory neural network layers).

Additionally, in one or more embodiments, a word embedding includes a numerical or vector representation of a word. For example, a word embedding can include a numerical or vector representation of a word included in a segment of text. In one or more embodiments, a word embedding includes a numerical or vector representation generated based on an analysis of the corresponding word. For example, in some embodiments, the text emphasis system utilizes a word embedding layer of a neural network or other embedding model to analyze a word and generate a corresponding word embedding. To illustrate, the text emphasis system can generate word embeddings (e.g., load or map words from a segment of text to embedding vectors) using a GloVe algorithm or an ELMo algorithm.

Similarly, a feature vector can also include a set of numerical values representing one or more words in a text segment. In one or more embodiments, however, a feature vector includes a set of numerical values generated based on an analysis of one or more word embeddings or other feature vectors. For example, in some embodiments, the text emphasis system utilizes an encoding layer of a text label distribution neural network (e.g., one or more bi-directional long short-term memory neural network layers to capture sequence information) to generate feature vectors corresponding to a plurality of words based on the word embeddings corresponding to those words. Accordingly, a feature vector can include a set of values corresponding to latent and/or hidden attributes and characteristics related to one or more words.

In one or more embodiments, an attention mechanism includes a neural network component that generates values (e.g., weights, weighted representations, or weighted feature vectors) corresponding to attention-controlled features. Indeed, an attention mechanism can generate values that emphasize, highlight, or call attention to one or more word embeddings or hidden states (e.g., feature vectors). For example, an attention mechanism can generate weighted representations based on the output representations of the respective neural network encoder (e.g., the final outputs of the encoder and/or the outputs of one or more of the neural network layers of the encoder) utilizing parameters learned during training. Accordingly, an attention mechanism can focus analysis of a model (e.g., a neural network) on particular portions of an input.

In some embodiments, an attention weight includes an output generated by an attention mechanism. For example, an attention weight can include a value or set of values generated by an attention mechanism. To illustrate, an attention weight can include a single value, a vector of values, or a matrix of values.

In one or more embodiments, a label distribution includes a probability distribution across a plurality of labels. For example, a label distribution can include a distribution of probabilities where each probability corresponds to an emphasis label from a text emphasis labeling scheme (also referred to as a labeling scheme) and provides the likelihood that the word corresponding to the label distribution is associated with that particular label. A text emphasis labeling scheme can include a plurality of labels that provide an emphasis designation for a given word. A label within a text emphasis labeling scheme includes a particular emphasis designation. For example, a text emphasis labeling scheme can include a binary labeling scheme comprised of a label for emphasis and a label for non-emphasis (e.g., an IO labeling scheme where the “I” label corresponds to emphasis and the “O” label corresponds to non-emphasis). Accordingly, a label distribution corresponding to the binary tagging scheme can include an emphasis probability and a non-emphasis probability. As another example, a text emphasis labeling scheme can include an inside-outside-beginning (IOB) labeling scheme comprised of labels that provide an inside, an outside, or a beginning designation. Accordingly, a label distribution corresponding to the inside-outside-beginning labeling scheme can include an inside probability, an outside probability, and a beginning probability. A text emphasis labeling scheme can include various numbers of labels.

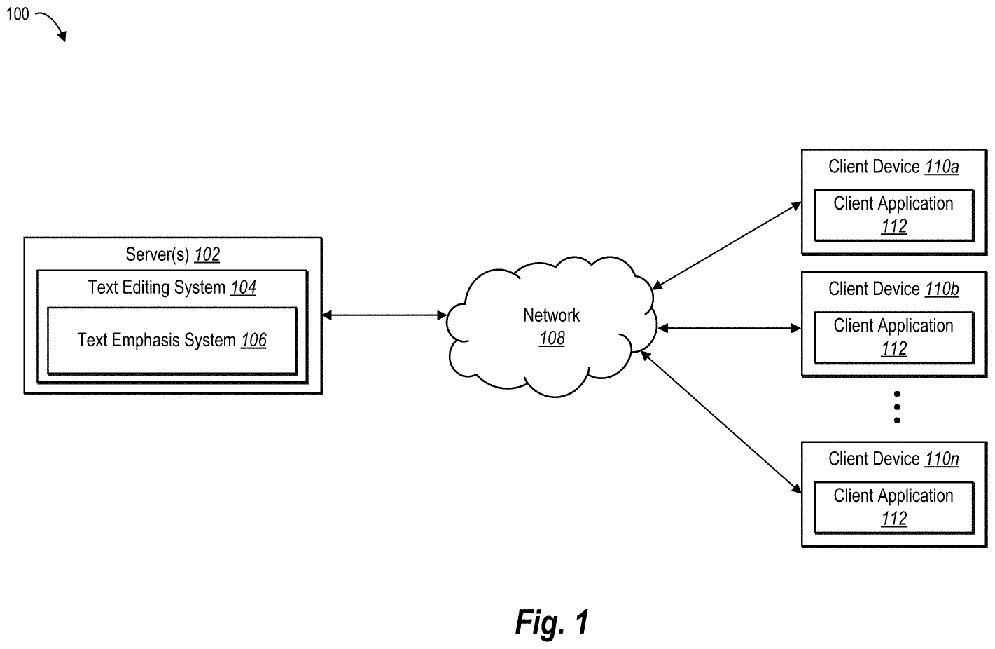

Additional detail regarding the text emphasis system will now be provided with reference to the figures. For example, FIG. 1 illustrates a schematic diagram of an exemplary system environment (“environment”) 100 in which a text emphasis system 106 can be implemented. As illustrated in FIG. 1, the environment 100 includes a server(s) 102, a network 108, and client devices 110a-110n.

Although the environment 100 of FIG. 1 is depicted as having a particular number of components, the environment 100 can have any number of additional or alternative components (e.g., any number of servers, client devices, or other components in communication with the text emphasis system 106 via the network 108). Similarly, although FIG. 1 illustrates a particular arrangement of the server(s) 102, the network 108, and the client devices 110a-110n, various additional arrangements are possible.

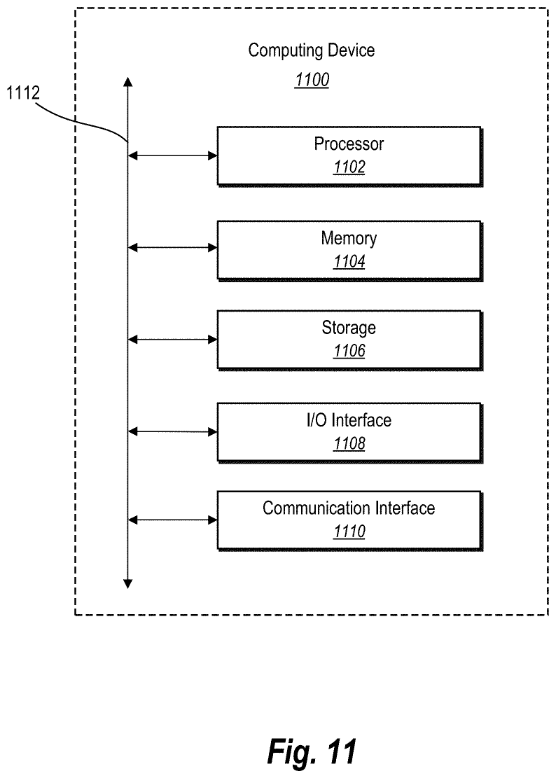

The server(s) 102, the network 108, and the client devices 110a-110n may be communicatively coupled with each other either directly or indirectly (e.g., through the network 108 discussed in greater detail below in relation to FIG. 11). Moreover, the server(s) 102 and the client devices 110a-110n may include a variety of computing devices (including one or more computing devices as discussed in greater detail with relation to FIG. 11).

As mentioned above, the environment 100 includes the server(s) 102. The server(s) 102 generates, stores, receives, and/or transmits data, including segments of text and modified segments of text that emphasize one or more words included therein. For example, the server(s) 102 can receive a segment of text from a client device (e.g., one of the client devices 110a-110n) and transmit a modified segment of text back to the client device. In one or more embodiments, the server(s) 102 comprises a data server. The server(s) 102 can also comprise a communication server or a web-hosting server.

As shown in FIG. 1, the server(s) 102 includes a text editing system 104. In particular, the text editing system 104 generates, accesses, displays, formats, and/or edits (e.g., modify) text. For example, a client device can generate or otherwise access a segment of text (e.g., using the client application 112). Subsequently, the client device can transmit the segment of text to the text editing system 104 hosted on the server(s) 102 via the network 108. The text editing system 104 can employ various methods to edit the segment of text or provide various options by which a user of the client device can edit the segment of text.

Additionally, the server(s) 102 includes the text emphasis system 106. In particular, in one or more embodiments, the text emphasis system 106 utilizes the server(s) 102 to modify segments of text to emphasize one or more words included therein. For example, the text emphasis system 106 uses the server(s) 102 to identify (e.g., receive) a segment of text that includes a plurality of words and then modify the segment of text to emphasize one or more of the words.

For example, in one or more embodiments, the text emphasis system 106, via the server(s) 102, identifies a segment of text that includes a plurality of words. Via the server(s) 102, the text emphasis system 106 utilizes a text label distribution neural network to employ (e.g., analyze) word embeddings corresponding to the plurality of words from the segment of text and generate a plurality of label distributions for the plurality of words based on the word embeddings. In particular, the text emphasis system 106 generates the plurality of label distributions by determining, for a given word, a distribution of probabilities across a plurality of emphasis labels in a text emphasis labeling scheme. In one or more embodiments, the text emphasis system 106, via the server(s) 102, further modifies the segment of text to emphasize one or more words from the plurality of words based on the plurality of label distributions.

In one or more embodiments, the client devices 110a-110n include computer devices that submit segments of text and receive modified segments of text that emphasize one or more words included therein. For example, the client devices 110a-110n include smartphones, tablets, desktop computers, laptop computers, or other electronic devices. The client devices 110a-110n include one or more applications (e.g., the client application 112) that submit segments of text and receive modified segments of text that emphasize one or more words included therein. For example, the client application 112 includes a software application installed on the client devices 110a-110n. Additionally, or alternatively, the client application 112 includes a software application hosted on the server(s) 102, which may be accessed by the client devices 110a-110n through another application, such as a web browser.

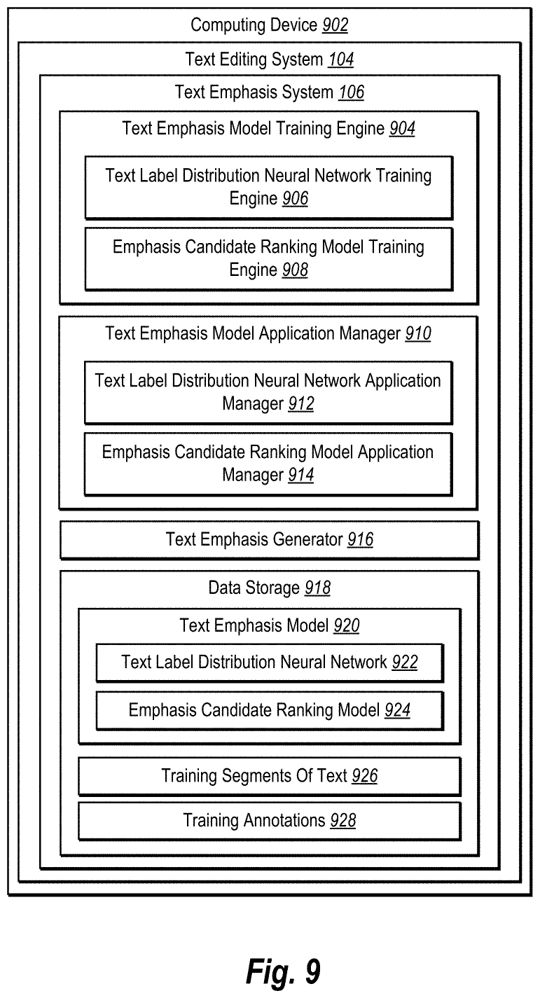

The text emphasis system 106 can be implemented in whole, or in part, by the individual elements of the environment 100. Indeed, although FIG. 1 illustrates the text emphasis system 106 implemented with regard to the server(s) 102, different components of the text emphasis system 106 can be implemented in a variety of the components of the environment 100. For example, one or more components of the text emphasis system 106—including all components of the text emphasis system 106—can be implemented by a computing device (e.g., one of the client devices 110a-110n). Example components of the text emphasis system 106 will be discussed in more detail below with regard to FIG. 9.

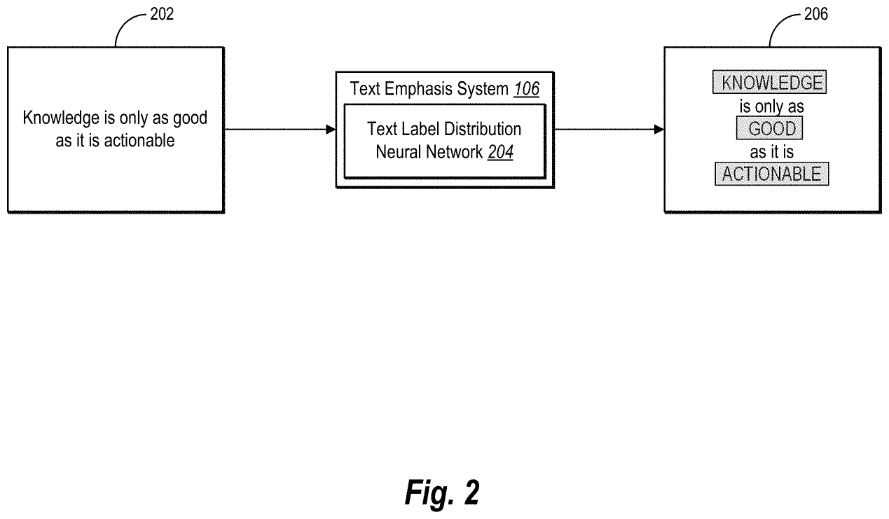

As mentioned above, the text emphasis system 106 modifies a segment of text to emphasize one or more words included therein. FIG. 2 illustrates a block diagram of the text emphasis system 106 modifying a segment of text to emphasize words included therein in accordance with one or more embodiments. As shown in FIG. 2, the text emphasis system 106 identifies a segment of text 202. In one or more embodiments, the text emphasis system 106 identifies the segment of text 202 by receiving the segment of text 202 from an external source, such as a third-party system or a client device. In some embodiments, the text emphasis system 106 identifies the segment of text 202 from a database storing text segments. In still further embodiments, the text emphasis system 106 identifies the segment of text 202 by transcribing the segment of text from audio content. Indeed, the text emphasis system 106 can receive or otherwise access audio content (e.g., from an audio recording or a live audio feed) and transcribe the audio content to generate the segment of text 202. In some instances, the text emphasis system 106 utilizes a third-party system to transcribe the audio content; accordingly, the text emphasis system 106 can receive a transcript as the segment of text 202.

As shown in FIG. 2, the segment of text 202 includes a plurality of words. While FIG. 2 (as well as many of the subsequent figures) may illustrate segments of text as short-form text content (e.g., a quote, a motto, or a slogan), it will be understood that the text emphasis system 106 is not so limited. Indeed, in some embodiments, the text emphasis system 106 analyzes and modifies segments of text that include long-form text content (e.g., a book, an article, or other document).

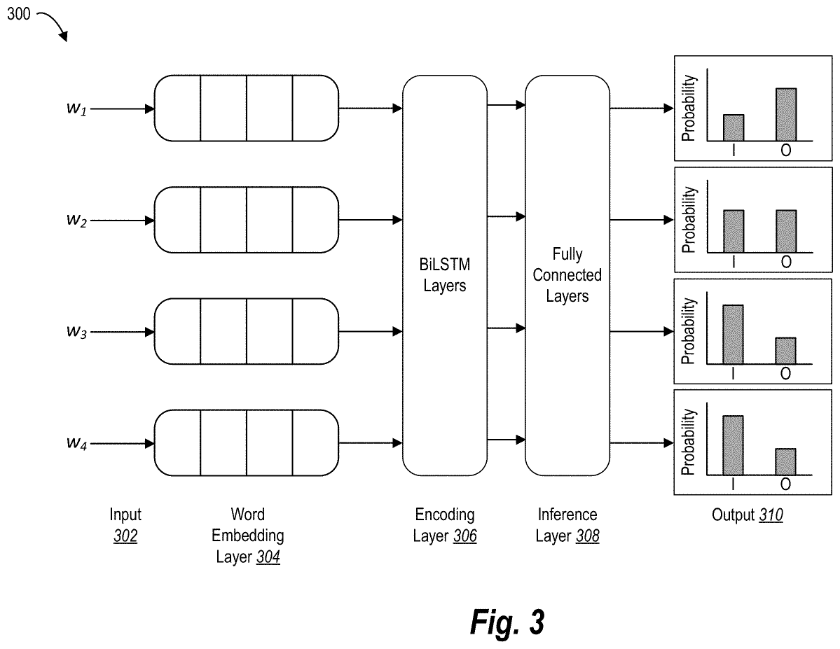

As illustrated in FIG. 2, the text emphasis system 106 utilizes a text label distribution neural network 204 to analyze the segment of text 202. In one or more embodiments, the text label distribution neural network 204 includes a long short-term memory neural network architecture. The architecture of the text label distribution neural network 204 will be discussed in more detail below with regards to FIG. 3.

In one or more embodiments, the text emphasis system 106 utilizes the text label distribution neural network 204 to identify (e.g., by generating label distributions, as will be discussed below with regard to FIG. 3) one or more words from a segment of text that are suitable for emphasis. In other words, the text emphasis system 106 utilizes the text label distribution neural network 204 to identify one or more words from a segment of text that the models determine will most accurately communicate the meaning of the segment of text when emphasized. In particular, the text label distribution neural network 204 learns label distributions that capture the common-sense selections (e.g., inter-subjectivity) across training annotations. Indeed, upon identifying a segment of text that includes a sequence of words (or other tokens) C={x₁, . . . , xₙ}, the text emphasis system 106 can utilize the text distribution neural network 204 to determine a subset S of the words in C that can accurately convey the meaning of the segment of text when emphasized. In one or more embodiments, 1≤|S|≤n.

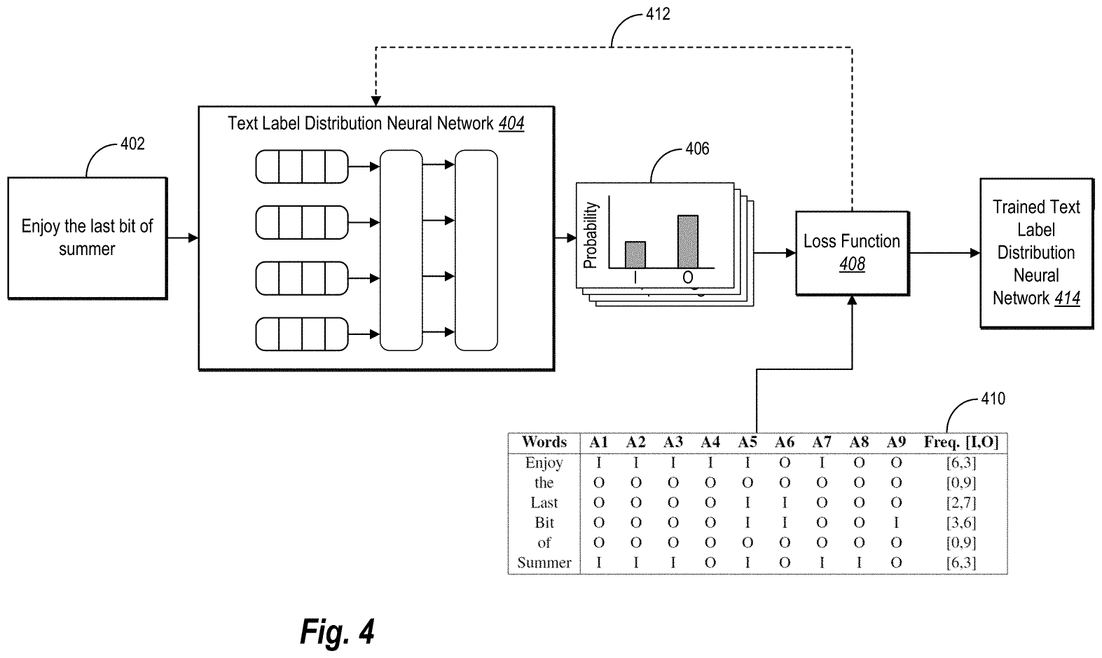

In one or more embodiments, the text emphasis system 106 trains the text label distribution neural network 204 to identify words for emphasis based on training annotations. Indeed, as will be discussed in more detail below with regard to FIG. 4, the text emphasis system 106 trains the text label distribution neural network 204 using training segments of text and corresponding annotations that provide annotator determinations of whether words in those training segments of text should be emphasized. Consequently, the text label distribution neural network 204 learns to generate label distributions that capture the common-sense selections (e.g., inter-subjectivity) reflected in training annotations.

As shown in FIG. 2, based on the analysis of the segment of text 202 by the text label distribution neural network 204, the text emphasis system 106 modifies the segment of text 202 (as shown by the modified segment of text 206). In particular, the text emphasis system 106 modifies the segment of text 202 to emphasize one or more of the words included therein. As shown in FIG. 2, the text emphasis system 106 can modify the segment of text 202 by highlighting and capitalizing each letter of the words selected for emphasis. The text emphasis system 106, however, can modify text segments using one or more various additional or alternative methods. For example, in one or more embodiments, the text emphasis system 106 modifies a segment of text by applying, to one or more words selected for emphasis, at least one of a color, a background, a text font, or a text style (e.g., italics, boldface, underlining, etc.).

As mentioned above, the text emphasis system 106 utilizes a text label distribution neural network to analyze a segment of text and generate corresponding label distributions. FIG. 3 illustrates a schematic diagram of a text label distribution neural network 300 in accordance with one or more embodiments.

As shown in FIG. 3, the text label distribution neural network 300 includes a word embedding layer 304. Indeed, as shown in FIG. 3, the text label distribution neural network 300 receives a segment of text that includes a plurality of words (shown as w₁, w₂, w₃, and w₄) as input 302. The text label distribution neural network 300 uses the word embedding layer 304 to generate word embeddings corresponding to the plurality of words (i.e., based on the plurality of words). The word embedding layer 304 can utilize various word/contextual embedding algorithms to generate the word embeddings. For example, in one or more embodiments, the word embedding layer 304 generates the word embeddings using a GloVe algorithm. In some embodiments, the word embedding layer 304 generates the word embeddings using an ELMo algorithm. In some instances, the text emphasis system 106 generates word embeddings corresponding to the plurality of words (e.g., using a model separate from the text label distribution neural network 300) and provides the word embeddings as the input to the text label distribution neural network 300.

As further shown in FIG. 3, the text label distribution neural network 300 includes an encoding layer 306. In one or more embodiments, the text label distribution neural network 300 utilizes the encoding layer 306 to analyze the word embeddings generated by the word embedding layer 304. More specifically, the text label distribution neural network 300 utilizes the encoding layer 306 to encode and learn the sequence of word embeddings passed through the word embedding layer 304. Indeed, the text label distribution neural network 300 utilizes the encoding layer to generate feature vectors corresponding to the plurality of words received as input 302 based on the word embeddings.

As mentioned above, in one or more embodiments, the text label distribution neural network 300 includes a long short-term memory (LSTM) neural network architecture. Indeed, as shown in FIG. 3, the encoding layer 306 of the text label distribution neural network 300 includes one or more bi-directional long short-term memory neural network layers. For example, in one or more embodiments, the text label distribution neural network 300 includes at least two bi-directional long short-term memory neural network layers. The text label distribution neural network 300 can utilize the bi-directional long short-term memory neural network layers to analyze the features corresponding to the plurality of words in both forward and backward directions.

In one or more embodiments, the encoding layer 306 of the text label distribution neural network 300 further includes one or more attention mechanisms. The text label distribution neural network 300 utilizes the one or more attention mechanisms to generate attention weights corresponding to the plurality of words received as input 302. Indeed, the text label distribution neural network 300 generates the attention weights to determine the relative contribution of a particular word to the text representation (e.g., the contribution to the segment of text). Thus, utilizing the one or more attention mechanisms can facilitate accurately determining which words communicate the meaning of a segment of text.

In one or more embodiments, the text label distribution neural network 300 utilizes the one or more attention mechanisms to generate the attention weights based on output representations of the encoder. For example, in some embodiments, the text label distribution neural network 300 generates the attention weights based on hidden states (i.e., values) generated by one or more layers of the encoding layer 306 (e.g., one or more of the bi-directional long short-term memory neural network layers). Indeed, in some instances, the text label distribution neural network 300 utilizes the one or more attention mechanisms to generate the attention weights as follows:

aᵢ=softmax(ν^{T} tanh(Wₕhᵢ+bₕ)) (1)

In equation 1, aᵢ represents an attention weight at timestep i and hᵢ represents an encoder hidden state (e.g., one or more values generated by one or more layers of the encoding layer 306, such as those included in the feature vectors generated by the bi-directional long short-term memory neural network layers). Indeed, in one or more embodiments, the text label distribution neural network 300 utilizes the one or more attention mechanisms to generate the attention weights based on the output representations of the encoding layer 306. Further, ν and Wₕ represent parameters that the text label distribution neural network 300 learns during training. In one or more embodiments, the text label distribution neural network 300 utilizes the attention weights generated by the one or more attention mechanisms to augment the output of the encoding layer 306 as follows where zᵢ represents the element-wise dot product of aᵢ and hᵢ:

zᵢ=aᵢ·hᵢ (2)

Additionally, as shown in FIG. 3, the text label distribution neural network 300 includes an inference layer 308. Generally speaking, the text label distribution neural network 300 utilizes the inference layer 308 to generate output 310 based on the word embeddings corresponding to the plurality of words received as input 302. For example, the text label distribution neural network 300 can utilize the inference layer 308 to generate, as output 310, a plurality of label distributions for the plurality of words based on the corresponding feature vectors generated by the encoding layer 306. Where the encoding layer 306 includes one or more attention mechanisms, the text label distribution neural network 300 generates the plurality of label distributions further based on the attention weights corresponding to the plurality of words.

As shown in FIG. 3, the inference layer 308 includes one or more fully connected layers. For example, in one or more embodiments, the inference layer 308 includes at least two fully connected layers. In some embodiments, the text label distribution neural network 300 utilizes fully connected layers having a pre-determined size. The text label distribution neural network 300 can utilize fully connected layers of various sizes. For example, in some instances, the text label distribution neural network 300 utilizes fully connected layers each having a size of fifty.

As shown in FIG. 3, and as previously mentioned, the output 310 of the text label distribution neural network 300 includes a plurality of label distributions for the plurality of words received as input 302. Indeed, the text label distribution neural network 300 generates the plurality of label distributions by determining, for a given word, a distribution of probabilities across a plurality of emphasis labels in a text emphasis labeling scheme (e.g., utilizing the inference layer 308). In some instances, a probability included in a label distribution indicates the likelihood that the corresponding word is associated with a particular emphasis label (i.e., the emphasis designation associated with that emphasis label). In other words, the text label distribution neural network 300 can assign each word (or other token) x from the sequence of words (or tokens) C a real number d_{y}^{x} to each possible label, representing the degree to which y describes x. In one or more embodiments, the text label distribution neural network 300 normalizes the results (i.e., d_{y}^{x} ∈[0,1] and Σ_{y} d_{y}^{x}=1). Thus, the text emphasis system 106 utilizes the text label distribution neural network 300 to identify, via generated label distributions, one or more words from a segment of text that can accurately convey the meaning of the segment of text when emphasized.

By utilizing a text label distribution neural network to analyze a segment of text, the text emphasis system 106 can operate more flexibly than conventional systems. Indeed, the text emphasis system utilizes the text label distribution neural network to identify and analyze a variety of attributes of the plurality of words included in a segment of text. Thus, the text emphasis system flexibly avoids the limitations of selecting words for emphasis solely based on the visual attributes of those words. By modifying a segment of text to emphasize one or more words based on the analysis of the text label distribution neural network, the text emphasis system can more accurately communicate the meaning of the segment of text.

Thus, the text emphasis system 106 utilizes a text label distribution neural network 300 to analyze a segment of text and generate a plurality of label distributions for the plurality of words included therein. The algorithms and acts described with reference to FIG. 3 can comprise the corresponding structure for performing a step for generating a plurality of label distributions for the plurality of words utilizing a text label distribution neural network. Additionally, the text label distribution neural network architectures described with reference to FIG. 3 can comprise the corresponding structure for performing a step for generating a plurality of label distributions for the plurality of words utilizing a text label distribution neural network.

As previously mentioned, the text emphasis system 106 can train a text label distribution neural network to determine (e.g., generate) label distributions for words in text segments. FIG. 4 illustrates a block diagram of the text emphasis system 106 training a text label distribution neural network 404 in accordance with one or more embodiments.

As shown in FIG. 4, the text emphasis system 106 implements the training by providing a training segment of text 402 to the text label distribution neural network 404. The training segment of text 402 includes a plurality of words to be analyzed for emphasis. As outlined below, the text emphasis system 106 can train the label distribution neural network 404 by minimizing loss (e.g., the difference between a predicted distribution and a ground truth distribution). In particular, the text emphasis system 106 can utilize back propagation to update weights in the network end-to-end, to iteratively reduce the measure of loss and improve accuracy of the network.

In one or more embodiments, the text emphasis system 106 accesses or retrieves the training segment of text 402 from a text annotation dataset that includes previously-annotated text segments. In one or more embodiments, the text emphasis system 106 generates the text annotation dataset by collecting annotations for various text segments. For example, the text emphasis system 106 can generate or otherwise retrieve (e.g., from a platform providing access to text segments, such as Adobe Spark) a text segment that can be used to train the text label distribution neural network 404. The text emphasis system 106 can submit the text segment to a crowd-sourcing platform providing access to a plurality of annotators (e.g., human annotators or devices or other third-party systems providing an annotating service). Upon receiving a pre-determined number of annotations for the words in the text segment, the text emphasis system 106 can store the text segment and the corresponding annotations within the text annotation dataset. The text emphasis system 106 can utilize the text segment as a training segment of text to train the text label distribution neural network 404.

As shown in FIG. 4, the text emphasis system 106 utilizes the text label distribution neural network 404 to generate predicted label distributions 406 based on the training segment of text 402. Indeed, the text emphasis system 106 can utilize the text label distribution neural network 404 to generate the predicted label distributions 406 as described above with reference to FIG. 3. The predicted label distributions 406 can include a predicted label distribution for each word in the training segment of text 402. As illustrated by FIG. 4, a given predicted label distribution can include probabilities across labels from a labeling scheme (i.e., a text emphasis labeling scheme) for the corresponding word.

The text emphasis system 106 can utilize the loss function 408 to determine the loss (i.e., error) resulting from the text label distribution neural network 404 by comparing the predicted label distributions 406 corresponding to the training segment of text 402 with ground truth label distributions 410 corresponding to the training segment of text 402. In one or more embodiments, the text emphasis system 106 accesses or retrieves the ground truth label distributions 410 from the text annotation dataset from which the training segment of text 402 was retrieved. Indeed, the ground truth label distributions 410 can include the annotations collected and stored (e.g., via a crowd-sourcing platform) for the words included in the training segment of text 402.

As an illustration, FIG. 4 shows the ground truth label distributions 410 including annotations collected from nine different annotators for each word in the phrase “Enjoy the last bit of summer” included in the training segment of text 402. Using the annotations, the text emphasis system 106 determines a probability for each word. For example, as shown in FIG. 4, six annotators associated the word “Enjoy” with the “I” label (indicating those annotators thought the word should be emphasized) and three annotators associated “Enjoy” with the “O” label (indicating those annotators thought the word should not be emphasized). Accordingly, the text emphasis system 106 can determine that a probability distribution for the word “Enjoy” includes a probability of 67% for emphasis and a probability of 33% for non-emphasis (based on the [6,3] annotation distribution).

The text emphasis system 106 can utilize this probability distribution as the ground truth label distribution for the word “Enjoy.” For example, the text emphasis system 106 can compare the probability distribution (e.g., the 67% for emphasis and the 33% for non-emphasis) with the predicted label distribution for the word “Enjoy” as generated by the text label distribution neural network 404. Specifically, the text emphasis system 106 can apply the loss function 410 to determine a loss based on the comparison between the predicted label distribution and the ground truth label distribution for the word “Enjoy.” The text emphasis system 106 can similarly determine losses based on comparing predicted label distributions and ground truth label distributions corresponding to each word included in the training segment of text 402. In one or more embodiments, the text emphasis system 106 combines the separate losses into one overall loss.

In one or more embodiments, the loss function 408 includes a Kullback-Leibler Divergence loss function. Indeed, the text emphasis system 106 can use the Kullback-Leibler Divergence loss function as a measure of how one probability distribution P is different from a reference probability distribution Q. The text emphasis system 106 can utilize the Kullback-Leibler Divergence loss function to compare predicted label distributions with the ground truth label distributions as follows:

$$( P ‖ Q ) = {\sum }_{x ∈ X} P ( x ) log \frac{Q ( x )}{P ( x )} \qquad ( 3 )$$

The loss function 408, however, can include various other loss functions in other embodiments.

As shown in FIG. 4, the text emphasis system 106 back propagates the determined loss to the text label distribution neural network 404 (as indicated by the dashed line 412) to optimize the model by updating its parameters/weights. Consequently, with each iteration of training, the text emphasis system 106 gradually improves the accuracy with which the text label distribution neural network 404 can generate label distributions for segments of text (e.g., by lowering the resulting loss value). As shown, the text emphasis system 106 can thus generate the trained text label distribution neural network 414.

In some embodiments, rather than using ground truth label distributions, the text emphasis system 106 trains the text label distribution neural network 404 using ground truth emphasis labels. Indeed, the text label distribution neural network 404 can utilize, as ground truth, a single label that indicates whether a word should be emphasized or not emphasized. For example, the text emphasis system 106 can determine a ground truth emphasis label based on the annotations included in the text annotation dataset (e.g., if the collection of annotations corresponding to a particular word results in a probability of over 50% for the “I” label, the text emphasis system 106 can determine that the ground truth emphasis label for that word should include a label indicating emphasis). In some embodiments, however, the text emphasis system 106 trains the text label distribution neural network 404 to generate a single label for each word in a segment of text, indicating whether or not that word should be emphasized. In other embodiments, the text emphasis system 106 utilizes more than two labels (e.g., three or four labels).

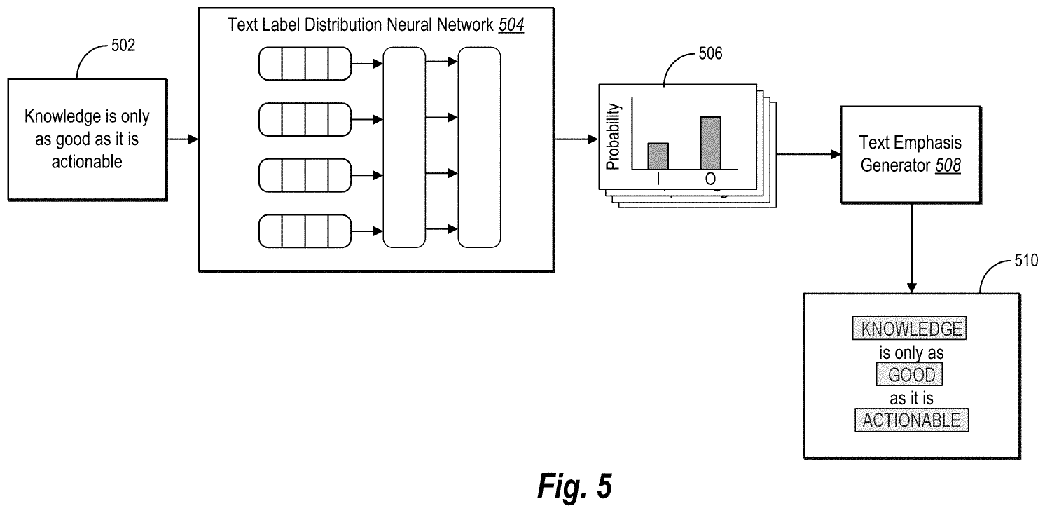

Based on the label distributions generated by the text label distribution neural network for a plurality of words included in a segment of text, the text emphasis system 106 can modify the segment of text to emphasize one or more of the words. FIG. 5 illustrates a block diagram of modifying a segment of text to emphasize one or more words in accordance with one or more embodiments. As shown in FIG. 5, the text emphasis system 106 utilizes a text label distribution neural network 504 to generate a plurality of label distributions 506 for a plurality of words included in a segment of text 502. The text emphasis system 106 can modify the segment of text 502 (e.g., utilizing a text emphasis generator 508) to emphasize one or more words from the plurality of words based on the plurality of label distributions 506 (as shown by the modified segment of text 510). As discussed above, the text emphasis system 106 can modify the segment of text 502 in various ways (e.g., applying, to the one or more words selected for emphasis, capitalization, highlighting, a color, a background, a text font, and/or a text style).

Further, the text emphasis system 106 can modify a segment of text based on corresponding label distributions using various methods. Indeed, the text emphasis system 106 can identify words for emphasis based on the probabilities included in their respective label distributions. For example, where the text emphasis system 106 utilizes a binary labeling scheme (e.g., including an “I” label corresponding to emphasis and an “O” label corresponding to non-emphasis), the text emphasis system 106 can determine whether or not to emphasize a particular word based on the probabilities associated the two included labels.

For example, in one or more embodiments, the text emphasis system 106 can identify a word from the plurality of words in a segment of text that corresponds to a top probability for emphasis based on the plurality of label distributions (i.e., by determining that the label distribution corresponding to the word includes a probability for emphasis—such as a probability associated with an “I” label of a binary labeling scheme—that is higher than the probability for emphasis included in the label distributions of the other words).

In one or more embodiments, a top probability for emphasis includes a probability associated with a label indicating that a word should be emphasized that is greater than or equal to the probabilities associated with the same label for other words. In particular, a top probability for emphasis can include a probability for emphasis associated with one word from a segment of text that is greater than or equal to the probability for emphasis associated with the other words from the segment of text. In one or more embodiments, multiple words can correspond to top probabilities for emphasis. For example, the text emphasis system 106 can identify a set of words from a segment of text, where each word in the set is associated with a probability for emphasis that is greater than or equal to the probabilities for emphasis associated with the other words from the segment of text outside of the set. As an illustration, the text emphasis system 106 can identify three words from the segment of text that are associated with a probability for emphasis that is greater than the probability for emphasis for any other word in the segment of text.

The text emphasis system 106 can modify the segment of text by modifying the identified word (e.g., and leaving the other words unmodified). In some embodiments, the text emphasis system 106 identifies a plurality of words corresponding to top probabilities for emphasis and modifies the segment of text by modifying those identified words. In some instances—such as where the text labeling scheme is not binary—the text emphasis system 106 can score each word from a segment of text based on the corresponding label distributions. Accordingly, the text emphasis system 106 can identify one or more words corresponding to top scores and modify the segment of text to emphasize those words.

In some embodiments, the text emphasis system 106 modifies one or more words from the plurality of words included in a segment of text differently based on the label distributions associated with those words. For example, the text emphasis system 106 can identify a first label distribution associated with a first word from the plurality of words and a second label distribution associated with a second word from the plurality of words. Accordingly, the text emphasis system 106 can modify the segment of text by applying a first modification to the first word based on the first label distribution and applying a second modification to the second word based on the second label distribution. As an illustration, the text emphasis system 106 may determine that a first word from a segment of text has a higher probability of emphasis than a second word from the segment of text based on the label distributions of those words (e.g., determine that the first word has a higher probability associated with the “I” label of a binary labeling scheme than the second word). Accordingly, the text emphasis system 106 can modify both the first and second words but do so in order to emphasize the first word more than the second word (e.g., making the first word appear larger, applying a heavier boldface to the first word than the second word, etc.).

In one or more embodiments, the text emphasis system 106 applies a probability threshold. Indeed, the text emphasis system 106 can preestablish a probability threshold that must be met for a word to be emphasized within a segment of text. The text emphasis system 106 can identify which words correspond to probabilities for emphasis (e.g., probabilities associated with the “I” label of a binary labeling scheme) that satisfy the probability threshold, based on the label distributions corresponding to those words, and modify the segment of text to emphasize those words.

In one or more embodiments, the text emphasis system 106 combines various of the above-described methods of modifying a segment of text based on corresponding label distributions. As one example, the text emphasis system 106 can identify a plurality of words corresponding to top probabilities for emphasis and modify those words based on their respective label distributions. In some embodiments, the text emphasis system 106 modifies a segment of text to emphasize one or more of the included words further based on other factors (e.g., length of the word) that may not be explicitly reflected by the label distributions.

As previously mentioned, the text emphasis system 106 can utilize the text label distribution neural network to generate label distributions that follow various other labeling schemes. Indeed, the text emphasis system 106 can utilize the text label distribution neural network to generate labeling schemes that are not binary, such as an inside-outside-beginning (IOB) labeling scheme. The text emphasis system 106 can modify a segment of text based on these various other labeling schemes as well.

For example, in one or more embodiments where the text label distribution neural network generates label distributions that follow the inside-outside-beginning (IOB) labeling scheme, the text emphasis system 106 can determine a probability in favor of emphasis based on the probabilities associated with the “I” and “B” labels and determine a probability in favor of non-emphasis based on the probability associated with the “O” label. Thus, the text emphasis system 106 can modify the segment of text using methods similar to those described above (e.g., identifying a word corresponding to a top probability for emphasis where the probabilities for emphasis are determined based on the probabilities of the “I” and “B” labels).

In one or more embodiments, the text emphasis system 106 can assign different weights to the different labels. For example, as described above, the text emphasis system 106 can generate a score for a segment of text based on its corresponding label distribution. The text emphasis system 106 can assign a weight the contributions of each label to that score. For example, where the text label distribution neural network generates label distributions that follow the IOB labeling scheme, the text emphasis system 106 can assign a first weight to probabilities associated with the “I” label and a second weight to probabilities associated with the “B” label (e.g., determining one of the labels to provide more value). Accordingly, the text emphasis system 106 can determine the probability for emphasis based on the weighted probabilities associated with the “I” and “B” labels.

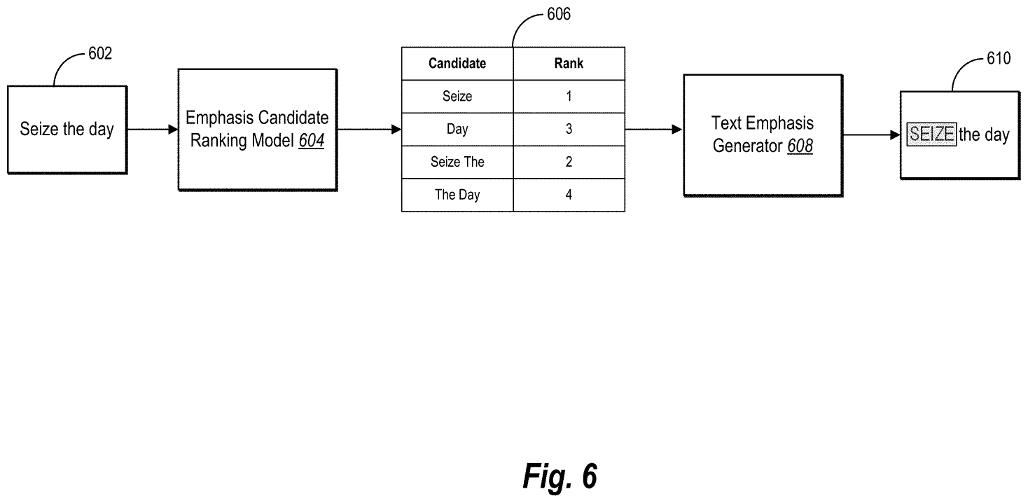

In one or more embodiments, the text emphasis system 106 utilizes an emphasis candidate ranking model (e.g., as an alternative, in addition to, or in combination with a text label distribution neural network) to identify one or more words for emphasis from a segment of text. FIG. 6 illustrates a block diagram of utilizing an emphasis candidate ranking model to identify a word for emphasis from a segment of text in accordance with one or more embodiments.

As shown in FIG. 6, the text emphasis system 106 provides a segment of text 602 to an emphasis candidate ranking model 604. The text emphasis system 106 can utilize the emphasis candidate ranking model 604 to rank the plurality of words from the segment of text 602 (as shown by the ranking table 606). In one or more embodiments, the text emphasis system 106 utilizes the emphasis candidate ranking model 604 to rank the plurality of words from the segment of text 602 by generating a set of candidates for emphasis that includes sequences of words (i.e., words and/or phrases) from the segment of text 602 and ranking the sequences of words from the set of candidates for emphasis.

To illustrate, the emphasis candidate ranking model 604 can generate the set of candidates for emphasis to include various sequences of words of various lengths. For example, in one or more embodiments, the emphasis candidate ranking model 604 generates the set of candidates for emphasis to include all sequences of one, two, and three words (also known as unigrams, bigrams, and trigrams, respectively) from the segment of text 602. In some instances, however, the emphasis candidate ranking model 604 generates the set of candidates for emphasis to include sequences of words of various other lengths.

In some embodiments, the emphasis candidate ranking model 604 excludes a sequence of words from the set of candidates for emphasis if the sequence of words incorporates the entire segment of text. For example, for the segment of text 602, which includes the phrase “Seize the day,” the emphasis candidate ranking model 604 can generate the set of candidates for emphasis to include “Seize,” “day,” “Seize the,” and “the day”. In some instances, however, the emphasis candidate ranking model 604 includes a sequence of words in the set of candidates for emphasis even if the sequence of words incorporates the entire segment of text. Further, in some embodiments, the emphasis candidate ranking model 604 excludes a sequence of words from the set of candidates for emphasis if the sequence of words only contains stop words—words, such as “the” or “and”.

As mentioned, the emphasis candidate ranking model 604 can further rank the sequences of words included in the set of candidates for emphasis (i.e., candidate sequences). In one or more embodiments, the emphasis candidate ranking model 604 ranks the candidate sequences based on a plurality of factors. For example, the emphasis candidate ranking model 604 can analyze word-level n-grams and character-level n-grams associated with the candidate sequences with a term frequency-inverse document frequency (TF-IDF) weighting. In some embodiments, the emphasis candidate ranking model 604 analyzes binary word-level n-grams (which only considers the presence or absence of terms). The emphasis candidate ranking model 604 can further rank a candidate sequence based on many syntactic, semantic, and sentiment features including, but not limited to, the relative position of the candidate sequence within the segment of text 602, part-of-speech tags assigned to one or more of the words in the candidate sequence, dependency parsing features associated with the candidate sequence, word embeddings or semantic vectors (e.g., generated by Word2Vec) corresponding to the candidate sequence, and/or sentiment polarities assigned to the candidate sequence (e.g., a label indicating that the candidate sequence is highly positive, highly negative, etc.). In one or more embodiments, the emphasis candidate ranking model 604 generates a score for the candidate sequences based on the various analyzed factors and further ranks the candidate sequences based on the generated scores.

In one or more embodiments, the text emphasis system 106 trains the emphasis candidate ranking model 604 to generate sets of candidates for emphasis and rank the sequences of words from the sets of candidates for emphasis. For example, the text emphasis system 106 can generate a text emphasis dataset that includes training segments of text and corresponding ground truths. The text emphasis system 106 can use the text emphasis dataset for training the emphasis candidate ranking model 604. In one or more embodiments, the text emphasis dataset includes the same data as the text annotation dataset discussed above with reference to FIG. 4 (i.e., training segments of text and ground truth label distributions based on collected annotations).

In some instances, however, rather than storing ground truth label distributions based on collected annotations, the text emphasis system 106 stores, within the text emphasis dataset, ground truth emphasis labels. For example, the text emphasis system 106 can determine a ground truth emphasis label (e.g., a binary label indicating emphasis or non-emphasis) for a training segment of text based on the annotations collected for that training segment of text. To illustrate, the text emphasis system 106 can determine the ground truth emphasis label based on majority voting with more than a specified threshold. Indeed, in one or more embodiments, the text emphasis system 106 associates positive or negative labels for each candidate indicating as emphasis or non-emphasis. As the number of negative candidates may exceed the number of positive candidates, the text emphasis system 106 can use an under-sampling technique to balance the number of positive and negative candidates (e.g., to prevent the emphasis candidate ranking model 604 from biased decisions).

In one or more embodiments, the text emphasis system 106 trains the emphasis candidate ranking model 604 using methods similar to training the text label distribution neural network discussed above with reference to FIG. 4. In particular, the text emphasis system 106 can utilize the emphasis candidate ranking model 604 to analyze a training segment of text (e.g., from the text emphasis dataset) and generate predicted emphasis labels for predicted candidate sequences, compare the predicted emphasis labels to corresponding ground truths (e.g., ground truth emphasis labels), and back propagate the resulting losses to modify the parameters of the emphasis candidate ranking model 604. In one or more embodiments, the text emphasis system 106 utilizes a logistic regression classifier to train and test the emphasis candidate ranking model 604. In one or more embodiments, the emphasis candidate ranking model 604 employs a support vector machine algorithm and the text emphasis system 106 trains the emphasis candidate ranking model 604 accordingly.

As shown in FIG. 6, based on the rankings for the words from the segment of text 602 (i.e., the rankings for the sequences of words in the set of candidates for emphasis), the text emphasis system 106 can modify the segment of text 602 (e.g., utilizing a text emphasis generator 608) to emphasize one or more of the words included therein (as shown by the modified segment of text 610). Indeed, the text emphasis system 106 can modify the segment of text 602 by modifying one or more sequences of words included in the set of candidates for emphasis. For example, the text emphasis system 106 can modify the top-ranked sequence of words or some pre-determined number of the top-ranked sequences of words.

As indicated above, in one or more embodiments, the emphasis candidate ranking model 604 includes a machine learning model trained to generate a set of candidates for emphasis and rank the sequences of words included therein. Indeed, the text emphasis system 106 can train the emphasis candidate ranking model 604 to analyze and rank a sequence of words based on a plurality of factors (e.g., word-level n-grams and/or character-level n-grams with a TF-IDF weighting, binary word-level n-grams, relative position, part-of-speech tags, dependency parsing features, word embeddings or semantic vectors, and/or sentiment polarities). In one or more embodiments, the text emphasis system 106 trains a neural network to analyze these factors and identify one or more words from a segment of text for emphasis. For example, the text emphasis system 106 can train the neural network to generate a score (e.g., a probability for emphasis) for a given word based on an analysis of the above-mentioned or other factors. The text emphasis system 106 can then modify the segment of text to emphasize one or more of the words included therein based on the generated scores. In some embodiments, the text emphasis system 106 trains a neural network—such as the text label distribution neural network—to generate label distributions based on the above-mentioned or other factors.

By utilizing an emphasis candidate ranking model to analyze features of words in a text segment—such as those described above—the text emphasis system 106 can operate more flexibly than conventional systems. Indeed, by analyzing the various features, the text emphasis system 106 can avoid relying solely on visual attributes when selecting words for emphasis. Further, by selecting words for emphasis based on the various features, the text emphasis system 106 can more accurately identify words that communicate the meaning of a text segment when emphasized.

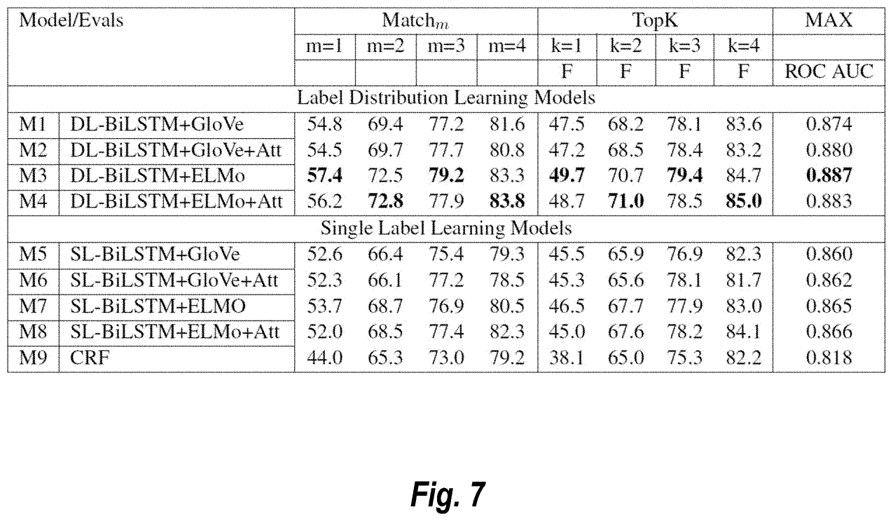

As mentioned above, utilizing a text label distribution neural network can allow the text emphasis system 106 to emphasize words that more accurately communicate the meaning of a segment of text. Researchers have conducted studies to determine the accuracy of one or more embodiments of the text label distribution neural network in identifying words for emphasis with agreement from human annotations. FIG. 7 illustrates a table reflecting experimental results regarding the effectiveness of the text label distribution neural network used by the text emphasis system 106 in accordance with one or more embodiments.

The researchers trained the embodiments of the text label distribution neural network (labeled with a “DL” designation) using the Adam optimizer with the learning rate set to 0.001. The researchers further used two dropout layers with a rate of 0.5 in the encoding and inference layers. Additionally, the researchers fine-tuned the embodiments of the text label distribution neural network for 160 epochs.

The table of FIG. 7 compares the performance of one embodiment of the text label distribution neural network that uses a pre-trained 100-dim GloVe embedding model for the word embedding layer, another embodiment that uses the pre-trained 100-dim GloVe embedding model for the word embedding layer and further uses one or more attention mechanisms in the encoding layer, one embodiment that uses a pre-trained 2048-dim ELMo embedding model for the word embedding layer, and another embodiments that uses the pre-trained 2048-dim ELMo embedding model for the word embedding layer and further uses one or more attention mechanisms in the encoding layer. The embodiments of the text label distribution neural network use bi-directional LSTM layers with hidden size of 512 and 2048 when using GloVe and ELMo embeddings, respectively.

Additionally, the table shown in FIG. 7 compares the performance of the text label distribution neural network with the performance of other methods of selecting words for emphasis. For example, the results also measure the performance of several models (labeled with a “SL” designation) that are similar in architecture to the tested embodiments of the text label distribution neural network. The input to these models, however, is a sequence of mapped labels and the negative log likelihood was used as the loss function in the training phase. Rather than utilizing label distribution learning, these models employ a single label learning approach. The results also measure the performance of a Conditional Random Fields (CRF) model with hand-crafted features including word identity, word suffix, word shape, and word part-of-speech tag for the current and nearby words. The CRF suite program is used for this model.

As shown in FIG. 7, the results compare the performance of each model using a Matchₘ evaluation setting. In particular, for each instance x in the test set Dₜₑₛₜ, the researchers selected a set Sₘ^{(x)} of m ∈{1 . . . 4} words with the top m probabilities according to the ground truth. Analogously, the researchers selected a prediction set Ŝₘ^{(x)} for each m, based on the predicted probabilities. The researchers defined the metric Matchₘ as follows:

$${Match}_{m} := \frac{{\sum }_{x ∈ {D}_{test}} \vert {S}_{m}^{( x )} ⋂ {\hat{S}}_{m}^{( x )} \vert / ( min ( m , \vert x \vert ) )}{\vert {D}_{t e s t} \vert} \qquad ( 4 )$$

Further the results compare the performance of each model using a TopK evaluation setting. Similar to Matchₘ, for each instance x, the researchers selected the top k={1, 2, . . . 4} words with the highest probabilities from both ground truth and prediction distributions.

Additionally, the results compare the performance of each model using a MAX evaluation setting. In particular, the researchers mapped the ground truth and prediction distributions to absolute labels by selecting the class with the highest probability. The researchers then computed ROC_AUC (e.g., a token with label probability of [I=0.75, O=0.25] is mapped to “I”).

As shown by the table of FIG. 7, the embodiments of the text label distribution neural network either outperformed or performed equally as well as the other models when considering all evaluation metrics. Notably, embodiments incorporating the ELMo model into the word embedding layer provided better results under the three evaluated metrics.

Additionally, utilizing an emphasis candidate ranking model can allow the text emphasis system 106 to emphasize words that more accurately communicate the meaning of a segment of text. Researchers have conducted studies to determine the accuracy of one or more embodiments of the emphasis candidate ranking model in identifying words for emphasis. Table 8 illustrates a table reflecting experimental results regarding the effectiveness of the emphasis candidate ranking model used by the text emphasis system 106 in accordance with one or more embodiments.

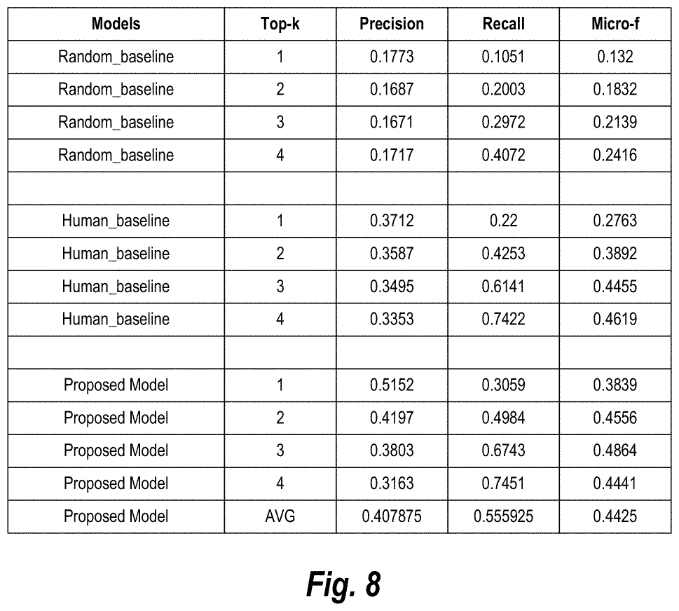

The results reflecting in the table of FIG. 8 provides the top-k k=1, 2, 3, 4) answers and compares them with a ground truth. In particular, the researchers score the outputs of the compared models by (1) creating a mapping between the key phrases in the gold standard (e.g., the ground truth) and those in the system output using exact match, and (2) score the output using evaluation metrics such as precision (P), recall (R), and F-score.

The table of FIG. 8 compares the performance of one or more embodiments of the emphasis candidate ranking model with various baseline models. For example, the table measures the performance of a model referred to as the “random baseline” model, which randomly chooses K phrases from candidates. The table further measures the performance of two variations of a model referred to as a “human baseline” model, selects K answers from a pool of all annotations.

As seen in FIG. 8, the emphasis candidate ranking model achieved higher results compared to the random baseline model and the human baseline model. In particular, the emphasis candidate ranking model significantly outperforms the random baseline model and generally outperforms the human baseline model, achieving similar results only where k=4.

Turning now to FIG. 9, additional detail will be provided regarding various components and capabilities of the text emphasis system 106. In particular, FIG. 9 illustrates the text emphasis system 106 implemented by the computing device 902 (e.g., the server(s) 102 and/or the client device 110a as discussed above with reference to FIG. 1). Additionally, the text emphasis system 106 is also part of the text editing system 104. As shown, the text emphasis system 106 can include, but is not limited to, a text emphasis model training engine 904 (which includes a text label distribution neural network training engine 906 and an emphasis candidate ranking model training engine 908), a text emphasis model application manager 910 (which includes a text label distribution neural network application manager 912 and an emphasis candidate ranking model application manager 914), a text emphasis generator 916, and data storage 918 (which includes a text emphasis model 920, training segments of text 926, and training annotations 928).

As just mentioned, and as illustrated in FIG. 9, the text emphasis system 106 includes the text emphasis model training engine 904. In particular, the text emphasis model training engine 904 includes the text label distribution neural network training engine 906 and an emphasis candidate ranking model training engine 908. The text label distribution neural network training engine 906 can train a text label distribution neural network to generate label distributions for a plurality of words included in a segment of text. For example, the text label distribution neural network training engine 906 can train the text label distribution neural network utilizing training segments of text and training label distributions generated based on training annotations. The text label distribution neural network training engine 906 can use the text label distribution neural network to predict label distributions for the plurality of words included in a training segment of text, compare the prediction to the corresponding training label distribution (i.e., as ground truth), and modify parameters of the text label distribution neural network based on the comparison.

In one or more embodiments, the text emphasis system 106 utilizes the emphasis candidate ranking model training engine 908. The emphasis candidate ranking model training engine 908 can train an emphasis candidate ranking model to generate a set of candidates for emphasis and rank the sequences of words included therein. For example, the emphasis candidate ranking model training engine 908 can train the emphasis candidate ranking model utilizing training segments of text and training emphasis labels generated based on training annotations. The emphasis candidate ranking model training engine 908 can use the emphasis candidate ranking model to predict emphasis labels for the plurality of words included in a training segment of text, compare the prediction to the corresponding training emphasis label (i.e., as ground truth), and modify parameters of the emphasis candidate ranking model based on the comparison.

Indeed, in one or more embodiments, the text emphasis system 106 can utilize a text label distribution neural network to generate label distributions or an emphasis candidate ranking model to generate a set of candidates for emphasis and rank the sequences of words included therein. For example, the text emphasis system 106 can utilize the emphasis candidate ranking model to analyze segments of text based on hand-crafted (i.e., administrator-determined) features, such as those described above with reference to FIG. 6. Or the text emphasis system 106 can utilize a text label distribution neural network to capture inter-subjectivity regarding a segment of text based on annotations corresponding to training segments of text. As another example, the text emphasis system 106 can utilize the candidate emphasis ranking model to generate phrase-based outputs and utilize the text label distribution neural network to generate word-based outputs. In one or more embodiments, the text emphasis system 106 can provide both models as an option and allow a user (i.e., an administrator) to select which model to implement.

In some embodiments, the text emphasis system 106 can utilize the text label distribution neural network and the emphasis candidate ranking model in conjunction with one another. For example, the text emphasis system 106 can utilize the output of one model (e.g., the text label distribution neural network) as the input to the other model (e.g., the emphasis candidate ranking model) to further refine the emphasis-selection process. In some instances, the text emphasis system 106 can select which words to emphasize based on the output of both models (e.g., select a word to emphasize if the emphasis candidate ranking model ranks a word within the top k words for emphasis and the text label distribution neural network provides a label distribution that favors emphasis for that word).

Additionally, as shown in FIG. 9, the text emphasis system 106 includes the text emphasis model application manager 910. In particular, the text emphasis model application manager 910 includes the text label distribution neural network application manager 912 and the emphasis candidate ranking model application manager 914. The text label distribution neural network application manager 912 can utilize the text label distribution neural network trained by the text label distribution neural network training engine 906. For example, the text label distribution neural network application manager 912 can utilize a text label distribution neural network to analyze a segment of text and generate a plurality of label distributions for the plurality of words included therein.

In one or more embodiments, the text emphasis system 106 utilizes the emphasis candidate ranking model application manager 914. The emphasis candidate ranking model application manager 914 can utilize the emphasis candidate ranking model trained by the emphasis candidate ranking model training engine 908. For example, the emphasis candidate ranking model application manager 914 can utilize an emphasis candidate ranking model to analyze a segment of text, generate a set of candidates for emphasis that includes sequences of words from the segment of text, and rank the sequences of words.

Further, as illustrated in FIG. 9, the text emphasis system 106 includes the text emphasis generator 916. In particular, the text emphasis generator 916 can modify a segment of text to emphasize one or more of the words included therein. For example, the text emphasis generator 916 can modify a segment of text based on label distributions generated by the text label distribution neural network application manager 912. The text emphasis generator 916 can modify the segment of text to emphasize one or more words corresponding to top probabilities for emphasis. The text emphasis generator 916 can also emphasize one or more words based on their corresponding label distributions (i.e., emphasize words differently depending on their respective label distribution). In one or more embodiments, the text emphasis generator 916 modifies a segment of text based on a ranking of sequences of words generated by the emphasis candidate ranking model application manager 914.

As shown in FIG. 9, the text emphasis system 106 further includes data storage 918 (e.g., as part of one or more memory devices). In particular, data storage 918 includes a text emphasis model 920, training segments of text 926, and training annotations 928. The text emphasis model 920 can store the text label distribution neural network 922. In particular, the text label distribution neural network 922 can include the text label distribution neural network trained by the text label distribution neural network training engine 906 and used by the text label distribution neural network application manager 912 to generate label distributions. In one or more embodiments, the text emphasis model 920 includes the emphasis candidate ranking model 924. In particular, the emphasis candidate ranking model 924 can include the emphasis candidate ranking model trained by the emphasis candidate ranking model training engine 908 and used by the emphasis candidate ranking model application manager 914. Training segments of text 926 and training annotations 928 store segments of text and annotations, respectively, used to train the text emphasis model—the text label distribution neural network or the emphasis candidate ranking model.

Each of the components 904-928 of the text emphasis system 106 can include software, hardware, or both. For example, the components 904-928 can include one or more instructions stored on a computer-readable storage medium and executable by processors of one or more computing devices, such as a client device or server device. When executed by the one or more processors, the computer-executable instructions of the text emphasis system 106 can cause the computing device(s) to perform the methods described herein. Alternatively, the components 904-928 can include hardware, such as a special-purpose processing device to perform a certain function or group of functions. Alternatively, the components 904-928 of the text emphasis system 106 can include a combination of computer-executable instructions and hardware.

Furthermore, the components 904-928 of the text emphasis system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 904-928 of the text emphasis system 106 may be implemented as a stand-alone application, such as a desktop or mobile application. Furthermore, the components 904-928 of the text emphasis system 106 may be implemented as one or more web-based applications hosted on a remote server. Alternatively, or additionally, the components 904-928 of the text emphasis system 106 may be implemented in a suite of mobile device applications or “apps.” For example, in one or more embodiments, the text emphasis system 106 can comprise or operate in connection with digital software applications such as ADOBE® SPARK or ADOBE® EXPERIENCE MANAGER. “ADOBE,” “SPARK,” and “ADOBE EXPERIENCE MANAGER” are either registered trademarks or trademarks of Adobe Inc. in the United States and/or other countries.

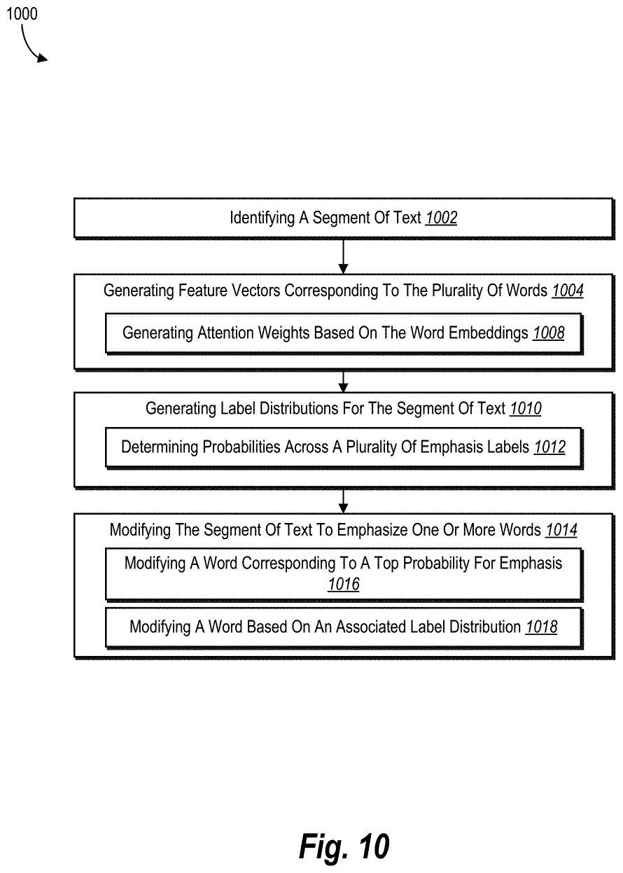

FIGS. 1-9, the corresponding text and the examples provide a number of different methods, systems, devices, and non-transitory computer-readable media of the text emphasis system 106. In addition to the foregoing, one or more embodiments can also be described in terms of flowcharts comprising acts for accomplishing the particular results, as shown in FIG. 10. FIG. 10 may be performed with more or fewer acts. Further, the acts may be performed in different orders. Additionally, the acts described herein may be repeated or performed in parallel with one another or in parallel with different instances of the same or similar acts.

As mentioned, FIG. 10 illustrates a flowchart of a series of acts 1000 for modifying a segment of text to emphasize one or more words included therein in accordance with one or more embodiments. While FIG. 10 illustrates acts according to one embodiment, alternative embodiments may omit, add to, reorder and/or modify any of the acts shown in FIG. 10. The acts of FIG. 10 can be performed as part of a method. For example, in some embodiments, the acts of FIG. 10 can be performed, in a digital medium environment for utilizing natural language processing to analyze text segments, as part of a computer-implemented method. Alternatively, a non-transitory computer-readable medium can store instructions that, when executed by at least one processor, cause a computing device to perform the acts of FIG. 10. In some embodiments, a system can perform the acts of FIG. 10. For example, in one or more embodiments, a system includes one or more memory devices comprising a segment of text comprising a plurality of words; and a text label distribution neural network trained to determine label distributions for text segment words. The system can further include one or more server devices that cause the system to perform the acts of FIG. 10.

The series of acts 1000 includes an act 1002 of identifying a segment of text. For example, the act 1002 involves identifying a segment of text comprising a plurality of words. In one or more embodiments, identifying the segment of text includes receiving the segment of text from an external source, such as a client device. In some embodiments, identifying the segment of text includes accessing the segment of text from storage. In some instances, however, identifying the segment of text comprises transcribing the segment of text from audio content.

The series of acts 1000 also includes an act 1004 of generating feature vectors corresponding to the plurality of words. For example, the act 1004 involves utilizing a text label distribution neural network to generate feature vectors corresponding to the plurality of words by processing word embeddings corresponding to the plurality of words from the segment of text utilizing an encoding layer of the text label distribution neural network. Indeed, in one or more embodiments, the text emphasis system 106 generates word embeddings corresponding to the plurality of words utilizing a word embedding layer of the text label distribution neural network. In some embodiments, however, the text emphasis system 106 generates the word embeddings and then provides the word embeddings as input to the text label distribution neural network.

In one or more embodiments, the text label distribution neural network is trained by comparing predicted label distributions across labels from a labeling scheme with ground truth label distributions across the labels from the labeling scheme. For example, the text label distribution neural network can be trained by comparing predicted label distributions, determined for words of a training segment of text, across labels from a labeling scheme with ground truth label distributions generated based on annotations for the words of the training segment of text. In one or more embodiments, comparing the predicted label distributions with the ground truth label distributions comprises utilizing a Kullback-Leibler Divergence loss function to determine a loss based on comparing the predicted label distributions with the ground truth label distributions.

In some instances, the encoding layer of the text label distribution neural network includes a plurality of bi-directional long short-term memory neural network layers. Accordingly, in one or more embodiments, the text emphasis system 106 generates, utilizing a plurality of bi-directional long short-term memory neural network layers of the text label distribution neural network, feature vectors corresponding to the plurality of words based on the word embeddings. In some embodiments, the encoding layer of the text label distribution neural network comprises at least two bi-directional long short-term memory neural network layers.

As shown in FIG. 10, the act 1004 includes the sub-act 1008 of generating attention weights based on the word embeddings. Indeed, in one or more embodiments, the text label distribution neural network includes one or more attention mechanisms. Accordingly, the text emphasis system 106 can generate attention weights corresponding to the plurality of words based on the word embeddings corresponding to the plurality of words utilizing the attention mechanisms of the text label distribution neural network. In some embodiments, the text emphasis system 106 generates the attention weights corresponding to the plurality of words based on the word embeddings by generating the attention weights based on the feature vectors corresponding to the plurality of words utilizing the attention mechanisms of the text label distribution neural network. Indeed, the text emphasis system 106 generates the attention weights utilizing the attention mechanisms further on the feature vectors generated by the encoding layer (e.g., generated by the plurality of bi-directional long short-term memory neural network layers).

Further, the series of acts 1000 includes an act 1010 of generating label distributions for the segment of text. For example, the act 1010 involves utilizing the text label distribution neural network to further generate (or otherwise determine), based on the feature vectors and utilizing an inference layer of the text label distribution neural network, a plurality of label distributions for the plurality of words. Where the text label distribution neural network includes one or more attention mechanisms that generates attention weights, the text emphasis system 106 can generate (or otherwise determine) the plurality of label distributions for the plurality of words based on the attention weights corresponding to the plurality of words.

The act 1010 includes the sub-act 1012 of determining probabilities across a plurality of emphasis labels. Indeed, the text emphasis system 106 can utilize the text label distribution neural network to generate, based on the feature vectors and utilizing an inference layer of the text label distribution of neural network, a plurality of label distributions for the plurality of words by determining, for a given word, a distribution of probabilities across a plurality of emphasis labels in a text emphasis labeling scheme. In other words, the text emphasis system 106 can determine, based on the feature vectors (corresponding to the word embeddings), a plurality of label distributions for the plurality of words by determining, for a given word, probabilities across a plurality of labels in a text emphasis labeling scheme utilizing an inference layer of the text label distribution neural network.

In one or more embodiments, the text emphasis labeling scheme comprises at least one of a binary labeling scheme, wherein the distribution of probabilities across the plurality of emphasis labels comprise an emphasis probability and a non-emphasis probability; or an inside-outside-beginning labeling scheme, wherein the distribution of probabilities across the plurality of emphasis labels comprise an inside probability, an outside probability, and a beginning probability. As discussed above, however, the text emphasis labeling scheme can include one of various other labeling schemes.

The series of acts 1000 further includes an act 1014 of modifying the segment of text to emphasize one or more words. For example, the act 1014 involves modifying the segment of text to emphasize one or more words from the plurality of words based on the plurality of label distributions. In one or more embodiments, the modifying the segment of text to emphasize the one or more words comprises applying, to the one or more words, at least one of a color, a background, a text font, or a text style (e.g., boldface, italics, etc.).

The text emphasis system 106 can modify the segment of text utilizing various methods. For example, as shown in FIG. 10, the act 1014 includes the sub-act 1016 of modifying a word corresponding to a top probability for emphasis. Indeed, the text emphasis system 106 can identify a word from the plurality of words corresponding to a top probability for emphasis based on the plurality of label distributions. Accordingly, the text emphasis system 106 can modify the segment of text to emphasize the one or more words from the plurality of words by modifying the identified word. In other words, the text emphasis system 106 can modify the segment of text to emphasize the identified word. In one or more embodiments, the text emphasis system 106 can emphasize multiple words having top probabilities for emphasis (i.e., word corresponding to probabilities for emphasis that meet a pre-determined threshold or some k number of words associated with the highest probabilities for emphasis). Accordingly, the text emphasis system 106 can identify words from the plurality of words corresponding to top probabilities for emphasis based on the plurality of label distributions; and modify the segment of text to emphasize the one or more words from the plurality of words based on the plurality of label distributions by modifying the identified words.

As shown in FIG. 10, the act 1014 further includes the sub-act 1018 of modifying a word based on an associated label distribution. For example, the text emphasis system 106 can modify the segment of text to emphasize the one or more words from the plurality of words by applying a first modification to a first word from the plurality of words based on a first label distribution associated with the first word; and applying a second modification to a second word from the plurality of words based on a second label distribution associated with the second word. More specifically, the text emphasis system 106 can identify a first label distribution associated with a first word from the plurality of words and a second label distribution associated with a second word from the plurality of words. Accordingly, the text emphasis system 106 can modify the segment of text to emphasize the one or more words from the plurality of words based on the plurality of label distributions by applying a first modification to the first word based on the first label distribution; and applying a second modification to the second word based on the second label distribution.

In one or more embodiments, the text emphasis system 106 employs the sub-act 1018 as an alternative to the sub-act 1016. In some embodiments, however, the text emphasis system 106 employs the sub-act 1018 in addition to the sub-act 1016. For example, the text emphasis system 106 can identify a plurality of words corresponding to top probabilities for emphasis and modify those words based on their respective label distributions.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., the server(s) 102 and/or the client devices 110a-110n). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 including storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium storing instructions thereon that, when executed by at least one processor, cause a computing device to:
identify a segment of text comprising a plurality of words;
utilize a text label distribution neural network to:
generate feature vectors corresponding to the plurality of words by processing word embeddings corresponding to the plurality of words from the segment of text utilizing an encoding layer of the text label distribution neural network; and
generate, based on the feature vectors and utilizing an inference layer of the text label distribution neural network, a plurality of label distributions for the plurality of words by determining, for a given word, a distribution of probabilities across a plurality of emphasis labels in a text emphasis labeling scheme; and
modify the segment of text to emphasize one or more words from the plurality of words based on the plurality of label distributions.

2. The non-transitory computer-readable medium of claim 1, further comprising instructions that, when executed by the at least one processor, cause the computing device to:
generate attention weights corresponding to the plurality of words based on the word embeddings corresponding to the plurality of words utilizing attention mechanisms of the text label distribution neural network; and
generate the plurality of label distributions for the plurality of words based on the attention weights corresponding to the plurality of words.

3. The non-transitory computer-readable medium of claim 2, further comprising instructions that, when executed by the at least one processor, cause the computing device to generate the attention weights corresponding to the plurality of words based on the word embeddings by:
generating the attention weights based on the feature vectors corresponding to the plurality of words utilizing the attention mechanisms of the text label distribution neural network.

4. The non-transitory computer-readable medium of claim 1, wherein the encoding layer of the text label distribution neural network comprises a plurality of bi-directional long short-term memory neural network layers.

5. The non-transitory computer-readable medium of claim 1, further comprising instructions that, when executed by the at least one processor, cause the computing device to:
identify a word from the plurality of words corresponding to a top probability for emphasis based on the plurality of label distributions; and
modify the segment of text to emphasize the one or more words from the plurality of words by modifying the identified word.

6. The non-transitory computer-readable medium of claim 1, further comprising instructions that, when executed by the at least one processor, cause the computing device to modify the segment of text to emphasize the one or more words from the plurality of words by:
applying a first modification to a first word from the plurality of words based on a first label distribution associated with the first word; and
applying a second modification to a second word from the plurality of words based on a second label distribution associated with the second word.

7. The non-transitory computer-readable medium of claim 1, further comprising instructions that, when executed by the at least one processor, cause the computing device to modify the segment of text to emphasize the one or more words by applying, to the one or more words, at least one of a color, a background, a text font, or a text style.

8. The non-transitory computer-readable medium of claim 1, wherein the text emphasis labeling scheme comprises at least one of:
a binary labeling scheme, wherein the distribution of probabilities across the plurality of emphasis labels comprise an emphasis probability and a non-emphasis probability; or
an inside-outside-beginning labeling scheme, wherein the distribution of probabilities across the plurality of emphasis labels comprise an inside probability, an outside probability, and a beginning probability.

9. The non-transitory computer-readable medium of claim 1, further comprising instructions that, when executed by the at least one processor, cause the computing device to identify the segment of text by transcribing the segment of text from audio content.

10. The non-transitory computer-readable of claim 1, wherein the text label distribution neural network is trained by comparing predicted label distributions across labels from a labeling scheme with ground truth label distributions across the labels from the labeling scheme.

11. A system comprising:
one or more memory devices comprising:
a segment of text comprising a plurality of words; and
a text label distribution neural network trained to determine label distributions for text segment words;
one or more server devices that cause the system to:
generate word embeddings corresponding to the plurality of words utilizing a word embedding layer of the text label distribution neural network;
generate, utilizing a plurality of bi-directional long short-term memory neural network layers of the text label distribution neural network, feature vectors corresponding to the plurality of words based on the word embeddings;
determine, based on the feature vectors, a plurality of label distributions for the plurality of words by determining, for a given word, a distribution of probabilities across a plurality of emphasis labels in a text emphasis labeling scheme utilizing an inference layer of the text label distribution neural network; and
modify the segment of text to emphasize one or more words from the plurality of words based on the plurality of label distributions.

12. The system of claim 11, wherein the one or more server devices cause the system to:
generate attention weights corresponding to the plurality of words based on the word embeddings corresponding to the plurality of words utilizing attention mechanisms of the text label distribution neural network; and
determine the plurality of label distributions for the plurality of words based on the attention weights corresponding to the plurality of words.

13. The system of claim 11, wherein the one or more server devices cause the system to:
identify words from the plurality of words corresponding to top probabilities for emphasis based on the plurality of label distributions; and
modify the segment of text to emphasize the one or more words from the plurality of words based on the plurality of label distributions by modifying the identified words.

14. The system of claim 11, wherein the one or more server devices cause the system to:
identifying a first label distribution associated with a first word from the plurality of words and a second label distribution associated with a second word from the plurality of words; and
modify the segment of text to emphasize the one or more words from the plurality of words based on the plurality of label distributions by:
applying a first modification to the first word based on the first label distribution; and
applying a second modification to the second word based on the second label distribution.

15. The system of claim 11, wherein the text label distribution neural network is trained by comparing predicted label distributions, determined for words of a training segment of text, across labels from a labeling scheme with ground truth label distributions generated based on annotations for the words of the training segment of text.

16. The system of claim 15, wherein comparing the predicted label distributions with the ground truth label distributions comprises utilizing a Kullback-Leibler Divergence loss function to determine a loss based on comparing the predicted label distributions with the ground truth label distributions.

17. The system of claim 11, wherein the one or more server devices cause the system to modify the segment of text to emphasize the one or more words from the plurality of words by applying, to the one or more words, at least one of a color, a background, a text font, or a text style.

18. In a digital medium environment for utilizing natural language processing to analyze text segments, a computer-implemented method comprising:
identifying a segment of text comprising a plurality of words;
performing a step for generating a plurality of label distributions for the plurality of words utilizing a text label distribution neural network; and
modifying the segment of text to emphasize one or more words from the plurality of words based on the plurality of label distributions.

19. The computer-implemented method of claim 18, wherein modifying the segment of text to emphasize the one or more words from the plurality of words comprises:
identifying a word from the plurality of words corresponding to a top probability for emphasis based on the plurality of label distributions; and
modifying the segment of text to emphasize the identified word.

20. The computer-implemented method of claim 18, wherein identifying the segment of text comprises transcribing the segment of text from audio content.
